(19) United States
(12) Patent Application Publication
(10) Pub. No.: US 2026/0270562 A1
(43) Pub. Date: Sep. 10, 2026

(54) ILLUMINATION ADAPTING METHOD AND PICTURE RECORDING ARRANGEMENT

(71) Applicant: ams-OSRAM AG, Premstätten (AT)

(72) Inventors: Raoul Mallart, Paris (FR); Josselin Manceau, Bagneux (FR); Enrico Cortese, Paris (FR)

(21) Appl. No.: 18/869,577

(22) PCT Filed: May 22, 2023
(86) PCT No.: PCT/EP2023/063594

§ 371 Date: Nov. 26, 2024

(30) Foreign Application Priority Data
Jun. 3, 2022 (DE) 10 2022 114 077.6

(51) Int. Cl. H04N 23/71; G06T 7/50; G06T 15/50; H04N 23/74

(52) U.S. Cl. CPC H04N 23/71; G06T 7/50; G06T 15/506; H04N 23/74

(57) ABSTRACT

In an embodiment a method includes providing a picture recording arrangement comprising an image sensor and a light source, the light source configured to illuminate a scene comprising a target along different emission directions, obtaining illumination information of at least one of a background of the scene or a reference image, the illumination information being based on a situation when the light source is turned off, generating an optimized weight vector based on the illumination information, the optimized weight vector including at least one intensity value for each one of the emission directions and taking at least one target image of the target by controlling light emission of the light source along the emission directions according to the optimized weight vector, wherein the target is indirectly illuminated so that at least some of the emission directions point next to the target and not onto the target.

### CROSS-REFERENCE TO RELATED APPLICATIONS

This patent application is a national phase filing under section 371 of PCT/EP2023/063594, filed May 22, 2023, which claims the priority of German patent application 102022114077.6, filed Jun. 3, 2022, each of which is incorporated herein by reference in its entirety.

### TECHNICAL FIELD

A method for adapting illumination and a picture recording arrangement are provided.

### BACKGROUND

Document JP 2022-003 372 A refers to a rotating flash unit.

### SUMMARY

Embodiments provide a picture recording arrangement and a corresponding method for improved image quality.

With the method and the picture recording arrangement described herein, for example, indirect illumination of a target to be imaged is used, and directions from which the indirect illumination comes from are adjusted by emitting a defined light pattern next to the target by controlling an adjustable photo flash which is realized in particular by a multi-LED light source.

According to at least one embodiment, the method is for adapting illumination. For example, by the method a photo flash is provided for taking images. The at least one image to be taken can be a single picture or can also be a series of pictures, like an animated image or a video.

According to at least one embodiment, the method includes the step of providing a picture recording arrangement. The picture recording arrangement comprises one or a plurality of image sensors, like CCD sensors. Further, the picture recording arrangement comprises one or a plurality of light sources, like an LED light source. The at least one light source is configured to illuminate a scene comprising a target to be photographed along different emission directions. In other words, the at least one light source is configured to provide a plurality of illuminated areas, for example, in surroundings of the target. The emission directions are different from each other in pairs so that there are no emission directions being parallel or congruent with each other.

The term ‘light source’ may refer to visible light, like white light or red, green and/or blue light, but can also include infrared radiation, for example, near-infrared radiation in the spectral range from 750 nm to 1.2 um. That is, along each emission direction visible light and/or infrared radiation can be emitted. For example, there are M emission directions wherein M is a natural number. For example, 2≤M≤40 or 6≤M≤30 or 10≤M≤20.

According to at least one embodiment, the method includes the step of obtaining illumination information of at least one of a background of the scene or a reference image, the illumination information is based on a situation when the light source being turned off. Hence, to get the illumination information no visible flash or the like is emitted by the picture recording arrangement. The illumination information may partially or completely be submitted to the picture recording arrangement by an external source or may partially or completely be calculated in the picture recording arrangement. For example, the illumination information is a background light pattern or an illumination pattern of the scene to be photographed later or is the mood of the reference image to be transferred to the image to be taken by the picture recording arrangement.

According to at least one embodiment, the method includes the step of generating an optimized weight vector based on the illumination information, the optimized weight vector includes at least one intensity value for each one of the emission directions.

It is possible that the weight vector is a row vector or also a column vector, depending on its use. In particular, a dimension of the vector is M or p*M wherein p is a natural number, in particular, p∈{1; 2; 3; 4}. For example, for optimizing the weight vector based on the illumination information an objective function can be used which may be a loss function.

According to at least one embodiment, the method includes the step of taking one or a plurality of target images of the target by controlling light emission of the light source along the emission directions according to the optimized weight vector. In other words, a light intensity of each one of the emission directions, or of a light-emitting unit of the light source corresponding to the respective emission direction, is encoded by the assigned intensity value of the optimized weight vector.

In at least one embodiment, the method is for adapting illumination and comprises the following steps, for example, in the stated order:
A) Providing a picture recording arrangement comprising an image sensor and a light source, the light source is configured to illuminate a scene comprising a target along different emission directions,
B) Obtaining illumination information of at least one of a background of the scene or a reference image, the illumination information is based on a situation when the light source being turned off,
C) Generating an optimized weight vector based on the illumination information, the optimized weight vector includes at least one intensity value for each one of the emission directions, and
D) Taking at least one target image of the target by controlling light emission of the light source along the emission directions according to the optimized weight vector.

In other words, for example, a method is provided to control a group of light-emitting units of a light source to match a target light distribution while illuminating a scene, without capturing any prior images of the actual scene, in particular with no emission of visible light out of the picture recording apparatus prior to taking the target image.

Cameras in mobile devices, like smart phones, are very small, and cannot receive a big amount of light and therefore behave poorly in low-light environment, producing images with a lot of noise. To get a good image exposition, it is common to try to add artificial lighting to the scene, by turning on some artificial light sources during image capture. The nature of this additional light can have a huge impact on the quality of the final picture, and the method described herein provides a solution to improve the way flash LEDs can bring light into a low-light scene. The method focuses on improving the quality of artificial flash for indoor environments.

One possibility to solve the problem of low-light photography is to take several images in a burst and merge them together using motion adaptation techniques in order to reduce the amount of motion blur. However, this solution is limited by the fact that it acquires images during several seconds and tries to merge them together, and is therefore prone to motion blur when taking pictures of moving objects.

Another possibility relies on very high ISO capabilities. Other image sensors are generally optimized for low ISO. Very high ISO generates a lot of noise, but noise reduction can be used. Although this solution is promising, the heavy denoising algorithms necessary to compensate for this very high ISO tend to clear out the details in the image.

The more standard and historical approach to the low-light problem is to use a flash to illuminate the scene. There are two main use cases for flashes in photography:
In some cases, it is possible to use external light sources that can be configured exactly as needed. Those sources often provide indirect lighting, that is light bouncing on a reflective surface and running then to the target to be photographed, or go through diffusers to avoid sharp shadows. This use case mainly concerns professional photographers who shoot in a studio as a controlled environment.
Sometimes, there is no control over the environment and the light source must remain very close to the camera, for example, in smart phones or small cameras. Therefore, the flash sends direct light to the scene, that is, there is a straight line between the light source and the photographed target, creating many problems such as strong reflections, bad shading, dazzling of a target by strong direct light, overexposure of close targets and/or sharp shadows.

In the latter specific use case, there are some possibilities to reduce the afore-mentioned problems:
A depth and RGB camera can be used to analyze the scene with a first RGBD capture, then use a video projector to flash spatially distributed light, providing a better lighting of the background and avoiding overexposure of foreground objects.
Several LEDs of different colors covering the whole spectrum can be used. By analyzing the spectral distribution with a first picture without flash, and then controlling the LEDs to flash a light that either matches or compensates the initial distribution, an ambient mood can be preserved or an active white balance correction can be provided.
A standard flash unit can be mounted on a mobile structure attached to a digital single-lens reflex, DSLR, camera. By applying an algorithm that uses additional depth sensors and fisheye camera to analyze the scene, the best direction for the mobile flash can be derived.

In the method described herein, a picture recording arrangement is used that contains a set of, for example, M independently controlled light-emitting units, all close to the camera but each pointing in a different direction. A process or an algorithm is used that optimizes the intensity applied to each light-emitting unit during the flash. The weight applied to each light-emitting unit can be optimized according to different criteria.

The light-emitting units should be oriented so that the amount of light that directly enters the field of view of the camera, that is, of the image sensor, is as low as possible. Thus, direct light of standard flashes is replaced by indirect light, that bounces on a nearby surface in surroundings of the object to be photographed. For example, useful emission directions are oriented with an angle of about 60° with relation to the main optical axis and have a beam angle of around 25°.

The method optimizes the intensity of each of the, for example, M light sources, by finding an optimal vector A of p M weights, also referred to as λ, and for each λ it applies: λ∈[0; 1], to be applied to the light-emitting units. A weight of zero means that the corresponding light-emitting unit is turned off and a weight of one means the corresponding light-emitting unit is at full power.

The optimal intensities to be used can be found with the following steps, for example:
Capture information about the environment of the target to be shot, that is, of the scene. This can be performed in various ways as for example
Take a lowlight picture, without turning on the light source.
Estimate a 3D representation of the scene in the field of view of the image sensor with a 3D sensor or by estimating 3D from a monocular image.
Estimate a 3D representation of the scene including areas outside of the field of view of the image sensor via the image sensor of the phone and/or via a 3D sensor of the mobile device while the user moves the mobile device in front of the target. This approach may also be used, for example, in Augmented Reality applications.
Estimate the spatial distribution of light in the scene, for example, intensity and color, using a segmented ambient light sensor pointing to the scene.
Estimate a set of weights to apply to the individual light-emitting units in order to capture the best picture based on different types of applications. This estimation can be performed in various ways as for example:
Run the inference of a neural network trained to directly predict the best weights to be applied to the individual light-emitting units of the light source in order to capture the best picture based on different types of applications. All such applications share the fact that a task-specific dataset is needed to be gathered and that a ground truth target illumination is needed to be defined.
Estimate from the captured 3D representation of the environment surfaces that could advantageously reflect light from the light-emitting units onto the target. This can be done by geometric computation or ray-tracing. Based on the position of the surfaces, select which at least one light-emitting unit is to shine to exploit the surfaces to bounce the flash on. In this approach, the color and orientation of the surfaces can be important parameters to take into account.
Use computer graphics methods to render pictures of the scene. Each picture simulates, for example, the illumination of the scene by a single emission direction. The rendering can use the geometry of the scene as estimated in the previous step. It can also use an estimation of the geometrical distribution of the light.
Take the optimal weights predicted in the previous step and apply those weights to the corresponding light-emitting units to capture the final target image.

The neural network or the weight optimization method can be trained for different tasks, based on the result to be achieved of previous scenarios, for example.

One possibility to train such a neural network is to use a corresponding picture recording arrangement to make target images of various scenes in different application scenarios. The training can include:
Sequentially turning on each emission direction at maximum power and capture a corresponding calibration picture with just one emission direction served by the light source.

The neural network is then trained by linearly combining all the individual calibration images with the best weights, and to compute, for example, an L2 loss or any other regression loss between the composited image from the linear combination and the application-specific ground truth. In this way, the weights predicted by the neural network can be related with some specific vision tasks.

In the described algorithm, the weights λ can have, for example, any value between 0.0, that is, light turned off, and 1.0, that is, light turned on with maximum intensity. This scale is continuous, and every weight can take a virtually infinite number of values. It is even more true for the weight vector A that contains many of the weight values λ. The number of combinations is virtually infinite and the algorithm to optimize the vector can thus be comparably complex.

One could also imagine a system where the intensity of each light-emitting unit can only be chosen from a limited, finite set of values, like {0.0; 0.5; 1.0}. In this case, the number of combinations is finite. For example, for ten light-emitting units with only three possible intensities, the total number of possibilities is 3¹⁰=59049. One could then imagine a different type of algorithm, for example, a brute force algorithm testing all possibilities, to optimize the weights λ.

Depending on the application, an objective function, like a loss function, to be optimized can be chosen in training.

Some possible examples of application scenarios of the method described herein are:

### Ambient Light Preservation:

It is tried to illuminate the scene while preserving the ambient light and the visual mood from the low-light environment. Most of the time, even without artificial light, the scene is still weakly illuminated. The human eye is very good at adapting to low luminosity, and it is expected to take a picture that reproduces the world as the human eye saw it, that is, with the same light distribution but with good exposure.

In this case, the ground truth is the weight vector that corresponds to a picture that best matches with a “Long Exposure” image, that is, an image with the exact same content as a low-light image and taken from the exact same viewpoint, but with a longer exposure time. The loss function could be computed just considering the luminance channel of the target image and the predicted images, that represents just the brightness intensity component of an image.

### Style Transfer:

In this case it is tried to transfer the style of an arbitrarily chosen image to the final picture to be shot, by actively optimizing the flash. In this use case, it is considered that the color of the light emitted by each light-emitting unit can preferably also be independently controlled. Because in this case the light is preferably color-controlled, the weight vector A to be optimized is three times bigger. It contains intensity values for each color channel, that is, for red, green and blue, RGB for short, instead of one general intensity value.

In this case, the ground truth is the weight vector that corresponds to a picture which has spherical harmonics that best match those of the reference image. This vector represents the harmonic coefficients of the reference light in the LAB color space. This spherical harmonic representation can also be obtained by the target style reference image using an additional neural network trained to accomplish such decomposition. In this case, the target style reference image may be added as an additional input to the neural network.

### Scene Relighting:

The idea here is to use the picture recording arrangement to relight the scene to match any specific light conditions selected by a user and not only the ambient light. One application could be in the area of background customization for video conferences, where it is wanted to illuminate a face of a person in a way to match the illumination given by a selected background image.

In this case, the neural network could be trained using either synthetic images allowing to vary, for example, a high dynamic range image, HDRI, background with no effort or using the individual calibration images to obtain additional information, like foreground mask, normal maps and/or albedo, allowing to create ground-truth relit images according to a target HDRI lighting environment. Also in this case, it is possible to add the target HDR map among the vectors provided as input to the neural network.

To better understand the advantages of the method described herein, the main problems of flash photography discussed previously are noted again, as they are: strong reflections, bad shading, overexposure, dazzled target, sharp shadows. Taken in mind that the most popular for low-light mobile photography is currently to not use the flash at all and enhance the picture with night mode algorithms, the associated main disadvantages are: motion blur, artifacts.

In the method described herein, for example, use of two innovations is made. The first one is to use a set of light-emitting units that point in different emission directions, outside the field of view, the second is to control the intensity of those light-emitting units to match a reference illumination.

The use of bouncing light solves many problems of the direct flash. When the light bounces on a surface, it is equivalent to using a by far bigger light source placed on the respective surface; the size of this virtual light being equal to the footprint of the flash on said surface. Using such a light inherently removes strong reflections and sharp shadows.

The light optimization algorithm used is in particular designed to detect bad shading and overexposure caused by certain light sources and decrease their intensity to remove the problem. The fact that a final picture is shot with the weight vector applied to the light-emitting units means that no artifacts are present, like from heavy denoising, and that motion blur is reduced due to a shorter exposition time.

In summary, use of bouncing light removes strong reflections and sharp shadows, optimization of independent light-emitting units provides better shading and reduces overexposure, and to reshoot the picture without heavy denoising does not lead to any artifacts and reduces motion blur. Further, there is no need to wait for any pre-shoot image, so that the target image can be shoot faster and more user-friendly.

For example, the method can be used in the following embodiments and/or applications:

### Use in a Smartphone for Low-Light Photography

The main embodiment for the method described herein may concern mobile photography. If powerful enough LEDs with required light distribution for bouncing light can be miniaturized and put on the back of a smartphone, it becomes possible to take indoor flash pictures without all the disadvantages of direct artificial light.

### Colored Light

For example, for the style transfer application, another possible embodiment is to have colored light sources. In this case, it is possible to spatially distribute not only the light intensity, but also its spectrum. The control of the color of the light sources can be of different types.

For example, in case of RGB, the exact color of each light-emitting unit can be controlled over a wide range of values that cover the whole spectrum or gamut. In this case, the intensity is controlled by three parameters, for example, one for each channel, like red, blue and green. The algorithm used works exactly the same as indicated above, except it's optimizing a weight vector of three parameters per light-emitting unit instead of one in case of a single-color light source.

For example, in case of correlated color temperature, CCT for short, many light sources, including LEDs, can emit light on a reduced spectrum from “warm” to “cold”. The parameter that defines a light color on this scale is called the “temperature”. Recent mobile phones even propose a “dual-tone” flash that has one cold-white emitting LED and one warm-white emitting LED, and automatically choose a mix of the two in order to emit light at the CCT that best fits a scene.

Such a setting of a “dual-tone” flash can be used for each of the independent light-emitting units of the light source. In this case, the emitted light per emission direction is controlled by two parameters: the intensity and the temperature. The algorithm described above works exactly the same in this scenario, except it's optimizing a weight vector of two parameters per light-emitting unit instead of only one.

### Infrared Lights

The light source could also emit light in the infrared, IR for short, spectral range. In such a system, the camera would also have IR capabilities in order to see the light emitted by the IR source or IR sources. In this case, the intensity of the light-emitting units are optimized, for example, by having IR calibration pictures of all the emission directions in order to get information about emission directions to be served by the visible flash and/or by getting information about suitable surfaces next to the target for indirect lighting. In the first case, each emission direction can be equipped with an additional IR light-emitting unit for indirect lighting, in the latter case direct IR lighting can be provided. IR light can also be used to avoid dazzling the target; then the IR flash picture can be used to denoise the boosted low-light picture without losing the fine grain details.

The main advantage with this approach using an IR source is that no visible light comes out of the flash before taking the target image, therefore making it much less disturbing for people in the room and providing a much better user experience.

### Dynamic Visual Effects

Another way of controlling the emitted light is to have dynamic weights and permanent illumination instead of a flash. In order to create a specific mood, for video content creation, for example, the light-emitting units can be controlled dynamically to create visual effects such as standing near a campfire or being underwater. In this use case, the weights are constantly re-evaluated to fit with a target animation.

Further, it is possible to use additional sensors. That is, the number of input parameters to the optimization algorithm can be increased using, for example, information from a depth sensor and/or a wide-angle camera. Information from those sensors would give additional information for a better performing weights optimizer.

In a modification of the method, a different input image is used for the neural network. Instead of using the low-light image as input to the neural network, one could also imagine using the image captured by the picture recording arrangement under any different light conditions, for example, the one using all the light sources turned on.

One could even imagine using a set of said images as input to the network instead of using only one, since the information they contain is often complementary. The low-light image contains information about the ambient light distribution but remains very dark and shows no details. The full-flash picture with all light-emitting units on at full power erases a bit the ambient light but contains more light and more information about the scene composition.

In a modification of the method, there is a pre-shoot. In this case, optimizing the weights is done by using pre-shoot pictures, that is, calibration pictures. An algorithm as follows can optimize the intensity of each light-emitting direction by executing, for example, the following steps:
Take one picture per emission direction, in which only the corresponding light-emitting unit is turned on and the others are turned off.
Choose an arbitrary distribution for the weights, for example, all weights equal to one which means all light-emitting units at full power. Set of weights is called the weight vector.
Optimize the weight vector with a gradient descent algorithm. The gradient descent is an iterative optimization algorithm that will refine the weight vector by running, for example, the following optimization sequence a certain number of times:
Slightly change the weight vector.
Numerically combine the images according to their weight.
Run an objective function, like a loss function, that returns a numerical value telling if the result image is good or not.
Back-propagate a loss gradient to evaluate the next change to apply to the weight vector, in particular if the loss was improved by the last change, keep changing the weight vector in that direction, otherwise try a different one.
Once the optimal weight vector has been found, apply the weights to the emission direction and take the target image.
The objective function, or loss function, can differ depending on the result desired to be achieved. The previous method may be used to train the neural network as indicated above.

Another way of adjusting the weights would be to start by applying the weights to the light-emitting units and to look at the result directly through the camera lens to assess the quality of the shading. An iterative optimization can take place by progressively adjusting the weights according to what is visible in the camera preview, for example, by using a gradient descent. This is similar to using a pre-shoot, but without any requirement of pre-captured images as input parameters. This kind of method can be called “Flash auto-focus” because it behaves the same way as a camera “auto focus” that automatically adjusts the focus of the lens via what is called a “through-the-lens”, TTL, algorithm. This alternative is a TTL adjusting algorithm for a multiple bouncing flash.

According to at least one embodiment, the image sensor and the light source and preferably the target as well are in the same position throughout method steps B) and/or D). Thus, the picture recording arrangement may not move intentionally during and between steps B) and D).

According to at least one embodiment, in step D) the target is illuminated in an indirect manner so that all or some or a majority of the emission directions point next to the target. In other words, all or some or a majority of the emission directions do not point onto the target.

According to at least one embodiment, orientations of the light source's emission directions relative to the image sensor are fixed. That is, the emission directions do not vary their orientation relative to one another and relative to the image sensor.

According to at least one embodiment, a diameter of the light source is at most 0.3 m or is at most 0.2 m or is at most 8 cm or is at most 4 cm, seen in top view of the image sensor. Thus, the light source has, for example, lateral dimensions smaller than that of a mobile phone.

According to at least one embodiment, step B) comprises:
B1) Taking a low-light image of the scene with the light source being switched off. Hence, the low-light image is taken without emission of visible light from the picture recording arrangement to illuminate the scene.

According to at least one embodiment, step B) comprises:
B2) Estimating a three-dimensional representation of the scene within a field of view of the image sensor. Thus, surfaces suitable for reflection of light of the emission directions for providing indirect illumination can be found. In this case, these surfaces can be located in close proximity to the target.

According to at least one embodiment, step B) comprises:
B3) Estimating a three-dimensional representation of the scene next to the field of view of the image sensor.

Accordingly, the illumination information can comprise information about reflective surfaces next to the target.

According to at least one embodiment, step B) comprises:
B4) Analyzing illumination conditions of the reference image, wherein the illumination information comprises information about at least one direction of illumination used to take the reference image. Thus, it is possible that no picture is taken from the scene or no analyzing of a geometric structure of the scene is performed prior to taking the target image. This is possible because all the illumination information may come from the reference image which does not need to be in any factual correlation with the scene comprising the target.

Method steps B1), B2), B3) and B4) can be combined with each other.

According to at least one embodiment, step C) comprises:
C1) Feeding a neural network with the illumination information and running it to generate the optimized weight vector. Hence, optimization may be done based on a previously trained neural network.

According to at least one embodiment, step C) comprises:
C2) Estimate from the illumination information the reflective surfaces to be illuminated with the light source and calculating the optimized weight vector accordingly.

Hence, the illumination information can be based on the 3D information of the scene captured by the picture recording arrangement prior to taking the target image.

According to at least one embodiment, step C) comprises:
C3) based on the illumination information, simulating an illumination of the scene for each one of the emission directions. For example, per simulation the light source is assumed to emit radiation only along a subset of the emission directions, for example, by exactly one emission direction. In other words, based on the 3D information of the scene which may previously be captured by the picture recording arrangement the emission of light along the emission directions is simulated so that virtual calibration images can result. These virtual calibration images can be used in connection with an objective function, and the weight vector leads to a linear combination of the virtual calibration images resulting in a combined image to be compared with a desired result for the target image.

Method steps C1), C2) and C3) can be combined with each other.

According to at least one embodiment, the reference image is an image taken independently of the method described herein. Thus, there does not need to be any spatial and/or temporal connection between the location and time the reference image has been generated and the location and time the method is performed. For example, the reference image is an image downloaded from the internet, an image shared by another user, a picture taken from a movie or also a graphic generated by a computer or by another user. Hence, in principle the reference image can arbitrarily be chosen.

According to at least one embodiment, step C) comprises:
Computing a spherical harmonic representation of a reference ambient light distribution of the reference image. In other words, the illumination conditions present in the reference image are analyzed.

According to at least one embodiment, step C) comprises:
Computing a same spherical harmonic representation of a linear combination of at least some of the calibration pictures, the objective function comprises a metric between the two spherical harmonic representations. In other words, the illumination conditions of the composite image can be analyzed in the same way as in case of the reference image. The weight vector is optimized to resemble the illumination conditions of the reference image as good as possible with the light source. In this case, the light along the emission directions can be colored light, in particular RGB light, so that three color channels may be taken into consideration per emission direction for the optimization.

According to at least one embodiment, a foreground mask and/or a background mask is computed, for example, in the case of the scene relighting application.

According to at least one embodiment, an emission angle between an optical axis of the image sensor and all or a majority or some of the emission directions is at least 30° or is at least 45° or is at least 55°. Alternatively or additionally, this angle is at most 75° or is at most 70° or is at most 65°. Said angle may refer to a direction of maximum intensity of the respective emission direction.

According to at least one embodiment, for all or a majority or some of the emission directions an emission angle width per emission direction is at least 15° or is at least 25°. Alternatively or additionally, said angle is at most 45° or is at most 35°. Said angle may refer to a full width at half maximum, FWHM for short.

It is possible that the same emission parameters apply for all the emission directions or that the emission parameters differ between the emission directions.

According to at least one embodiment, the radiation emitted into the emission directions is emitted out of a field of view of the image sensor. That is, the radiation does not provide direct lighting of the target to be photographed.

According to at least one embodiment, there are at least six or at least 10 or at least 12 of the emission directions. Alternatively or additionally, there are at most 30 or at most 20 or at most 18 of the emission directions. For example, the number of emission directions is between 12 and 16 inclusive.

According to at least one embodiment, the light source comprises one light-emitting unit for each one of the emission directions. The light-emitting unit can be an emitter with one fixed emission characteristics or can also be an emitter with adjustable emission characteristics, like an RGB emitter, for example. It is possible that all light-emitting units are of the same construction, that is, of the same emission characteristics, or that there are light-emitting units with intentionally different emission characteristics.

According to at least one embodiment, positions of the light-emitting units relative to one another are fixed. That is, the light-emitting units cannot be moved relative to one another in intended use of the picture recording arrangement. Further, the light-emitting units can preferably not be moved relative to the image sensor in intended use of the picture recording arrangement.

According to at least one embodiment, the light-emitting units are arranged in a circular manner, seen in top view of the image sensor. For example, the image sensor may be arranged within the circle the light-emitting units are arranged on. The emission directions can be oriented inwards.

According to at least one embodiment, the light source comprises an additional light-emitting unit configured for direct lighting of the target. It is possible that said additional light-emitting unit is used in other situations and/or applications than the light-emitting units for indirect lighting. Hence, it is possible that both direct and indirect lighting may be addressed with the picture recording arrangement.

According to at least one embodiment, the method is performed indoor. Thus, the intended use case is in rooms and not in the open environment, in particular not in natural day light.

According to at least one embodiment, in step D) the light source emits a photo flash. Optionally, the light source can be configured for short-time or continuous lighting as well.

According to at least one embodiment, a distance between the picture recording arrangement and the target is at least 0.3 m or is at least 1 m. Alternatively or additionally, said distance is at most 10 m or is at most 6 m or is at most 3 m. In other words, the picture recording arrangement and the target are intentionally relatively close to one another.

According to at least one embodiment, the light source is configured to independently emit a plurality of beams having different colors along all or some or a majority of the emission directions. Thus, RGB light may be provided.

According to at least one embodiment, the light source is configured to emit only a single beam of light along at least some of the emission directions. Thus, the light source can have a single, fix color to be emitted. In this case, ‘color’ may refer to a specific coordinate in the CIE color table.

According to at least one embodiment, the light source comprises one or a plurality of emitters for non-visible radiation, like near-IR radiation. It is possible that there is only one common emitter for non-visible radiation or that there is one emitter for non-visible radiation per emission direction.

According to at least one embodiment, the picture recording arrangement comprises a 3D-sensor. By means of the 3D-sensor, the picture recording arrangement can obtain three-dimensional information of the scene, for example, prior to step C). The 3D-sensor can be, for example, based on a stereo camera set-up, on a time-of-flight set-up or on a reference pattern analyzing set-up.

According to at least one embodiment, the picture recording arrangement is a single device, like a single mobile device, including the image sensor as well as the light source and optionally the at least one additional light-emitting unit, the at least one emitter for non-visible radiation and/or the at least one 3D-sensor.

According to at least one embodiment, the picture recording arrangement is a mobile phone, like a smart phone.

A picture recording arrangement is additionally provided. The picture recording arrangement is controlled by means of the method as indicated in connection with at least one of the above-stated embodiments. Features of the picture recording arrangement are therefore also disclosed for the method and vice versa.

In at least one embodiment, the picture recording arrangement is a mobile device and comprises an image sensor, a light source and a processing unit, wherein
the processing unit is configured to obtain illumination information of at least one of a background of a scene comprising a target or a reference image, the illumination information is based on a situation when the light source being turned off,
the processing unit is further configured to generate an optimized weight vector based on the illumination information, the optimized weight vector includes at least one intensity value for each one of the emission directions, and
the image sensor is configured to take at least one target image of the target by controlling, by the processing unit, light emission of the light source along the emission directions according to the optimized weight vector.

### BRIEF DESCRIPTION OF THE DRAWINGS

A method and a picture recording arrangement described herein are explained in greater detail below by way of exemplary embodiments with reference to the drawings. Elements which are the same in the individual figures are indicated with the same reference numerals. The relationships between the elements are not shown to scale, however, but rather individual elements may be shown exaggeratedly large to assist in understanding.

FIG. 1 is a schematic side view of an exemplary embodiment of a method using a picture recording arrangement described herein;

FIG. 2 is a schematic front view of the method of FIG. 1;

FIG. 3 is a schematic block diagram of an exemplary embodiment of a method described herein;

FIGS. 4 and 5 are schematic representations of method steps of an exemplary embodiment of a method described herein;

FIG. 6 is a schematic representation of the emission characteristics of a light-emitting unit for exemplary embodiments of picture recording arrangements described herein;

FIGS. 7 and 8 are schematic top views of exemplary embodiments of picture recording arrangements described herein; and

FIGS. 9 and 10 are schematic sectional views of light-emitting units for exemplary embodiments of picture recording arrangements described herein.

### DETAILED DESCRIPTION OF ILLUSTRATIVE EMBODIMENTS

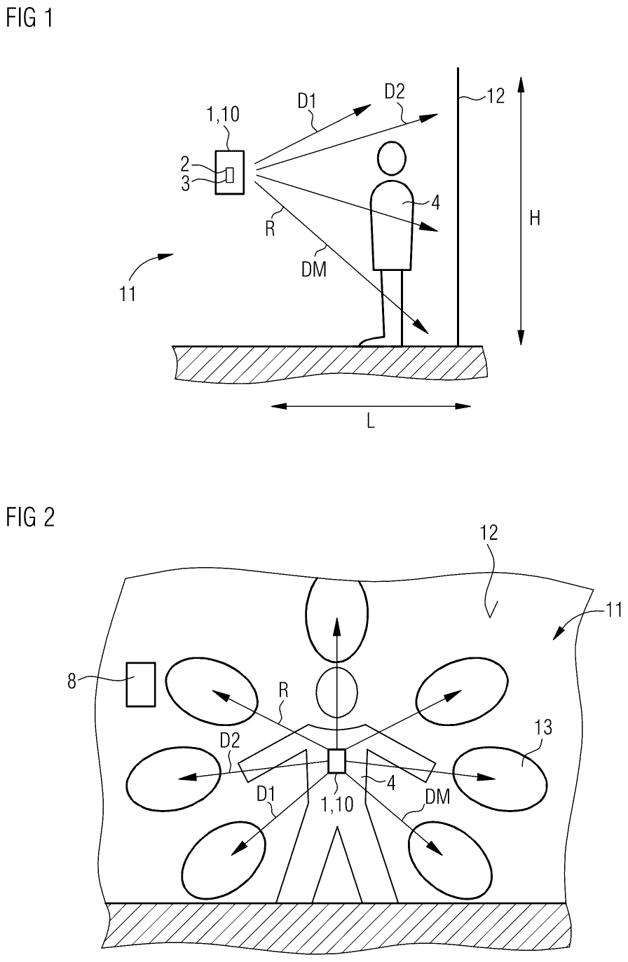

FIGS. 1 and 2 illustrate an exemplary embodiment of a method using a picture recording arrangement 1. The picture recording arrangement 1 is a mobile device 10 and comprises an image sensor 2 configured to take photos and/or videos. Further, the picture recording arrangement 1 comprises a light source 3. A user of the picture recording arrangement 1 is not shown in FIGS. 1 and 2.

In the intended use, the picture recording arrangement 1 is used indoors to take, for example, a target image IT of a target 4 in a scene 11. For example, the target 4 is a person to be photographed. For example, a distance L between the target 4 and the picture recording arrangement 1 is between 1 m and 3 m. It is possible that a size H of the target 4 is about 1 m to 2 m. The target 4 can be located in front of a wall 12 or any other item, for example, in front of the target 4 that provides a bouncing surface on the sides of the target 4 so that indirect lighting can be provided. The target 4 can be directly at the wall or can have some distance to the wall 12.

The light source 3 is configured to emit radiation R, like visible light and/or infrared radiation, along a plurality of emission directions D1 . . . DM. Thus, there are M emission directions. For example, M is between ten and 20 inclusive. By means of the light source 3, for example, for each one of the emission directions D1 . . . DM one illuminated area 13 is present next to the target 4 out of a field of view of the image sensor 2. Thus, the light source 3 provides indirect lighting. The emission of radiation along the emission directions D1 . . . DM can be adjusted by means of a processing unit of the picture recording arrangement 1.

For example, in the room the picture recording arrangement 1 and the target 4 are located there is a luminaire 8 that provides weak lighting. This mood provided by the luminaire 8 shall be reproduced by the picture recording arrangement 1. In order to do so and realizing a high picture quality, the light source 3 addresses, for example, in particular the illumination areas 13 being about in the same orientation relative to the target 4 as the luminaire 8. In FIG. 2, this would be, for example, the illumination areas 13 in the upper left area next to the luminaire 8. In this simple example, the mood can be kept while good illumination conditions can be present when taking the picture by having the light source 3 as an adapted photo flash.

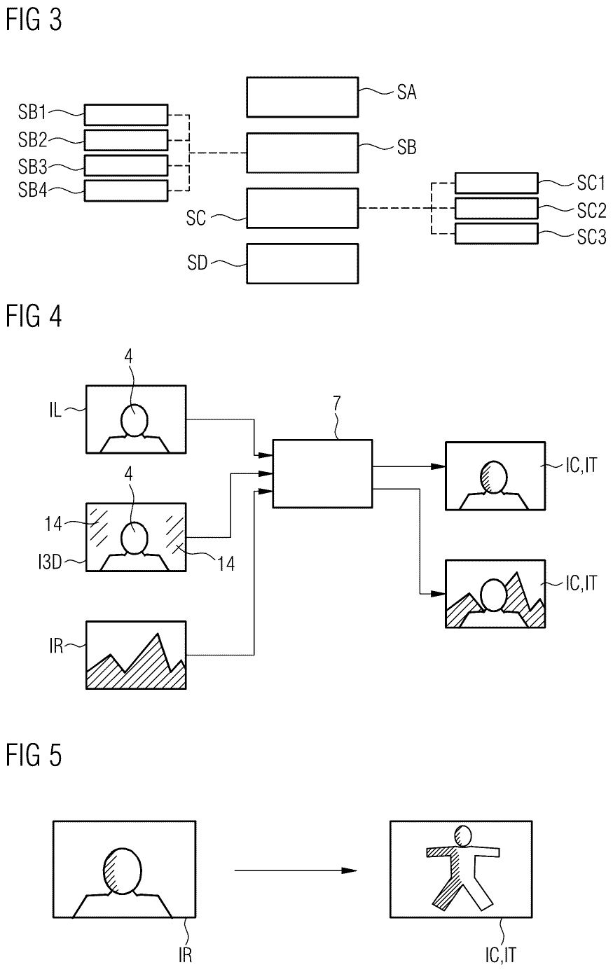

An example of the method to achieve this is schematically illustrated in connection with FIG. 3.

In method step SA, the picture recording arrangement 1 comprising the image sensor 2 and the light source 3 is provided, the light source 3 is configured to illuminate the scene 11 comprising the target 4 along the different emission directions D1 . . . DM.

In step SB, illumination information II of at least one of a background of the scene 11 or a reference image IR, is obtained the illumination information II is based on a situation when the light source 3 being turned off. Hence, for getting the illumination information II no visible light is emitted by the picture recording arrangement 1.

In method step SC, an optimized weight vector A based on the illumination information II is generated, the optimized weight vector A includes at least one intensity value λ for each one of the emission directions D1 . . . DM.

In method step SD, at least one target image IT of the target 4 is taken by controlling light emission of the light source 3 along the emission directions D1 . . . DM according to the optimized weight vector A. In other words, for example, a photo flash is emitted by serving the emission directions D1 . . . DM as previously calculated.

In FIG. 4 some optional aspects of the method of FIG. 3 are illustrated in more detail. Steps SB and SD are done by a processing unit 7.

As an input, for example, the processing unit 7 receives a low-light image IL of the scene 11 including the target 4. The illumination information is obtained from the low-light image IL. For example, there is some shading due to the illumination conditions, symbolized by some hatching. The illumination conditions are analyzed by the processing unit 7. The weight vector A is thus optimized to best resemble the illumination conditions for the target image IT. Accordingly, the method can include the step SB1 of taking the low-light image IL of the scene 11 with the light source 3 being switched off.

Further, in FIG. 4 it is illustrated that the input can be a three-dimensional representation I3D of the scene 11 around the target 4. Hence, reflective surfaces 14 like the wall 12 next to the target 4 can be found. The weight vector L is thus optimized to provide the desired illumination by addressing the emission directions D1 . . . DM suitable for the respective reflective surfaces 14. The reflective surfaces 14 may be Lambertian reflective surfaces. The three-dimensional representation I3D of the scene 11 can be within or also out of a field of view 22 of the image sensor 2. Accordingly, the method can include the steps SB2 and/or SB3 of analyzing the 3D situation of the scene 11 with the light source 3 being switched off.

It is possible that a composite image IC is simulated by the processing unit 7 based on, for example, the three-dimensional representation I3D. The composite image IC can be a linear combination of the emission directions D1 . . . DM being provided with radiation. The target picture IT can be taken with the weight vector A leading to the least difference between the composite image IC and a desired mood or ambient light conditions of the low-light image IL, for example.

Further, illumination conditions of the reference image IR can be analyzed, wherein the illumination information II then comprises information about at least one direction of illumination used to take the reference image IR. Accordingly, the method can include the step SB4 of analyzing the reference image IR, wherein for doing so the light source 3 can be irrelevant. It is possible that the reference image IR may be used as a virtual background for the target 4.

In FIG. 5 it is also illustrated that the reference image IR is provided. Illumination conditions are analyzed and extracted from the reference image IR, for example, by a neural network. The illumination conditions are symbolized in FIG. 5 by means of the indicated shading in the reference image IR.

Then, the weight vector A is optimized to resemble these illumination conditions as much as possible. This is indicated by the shading in the optional composite image IC that may be simulated. Accordingly, the mood of the reference image IR can be transferred to the target image IT.

Preferably, in this case of mood transfer, the emission directions D1 . . . DM each have RGB channels.

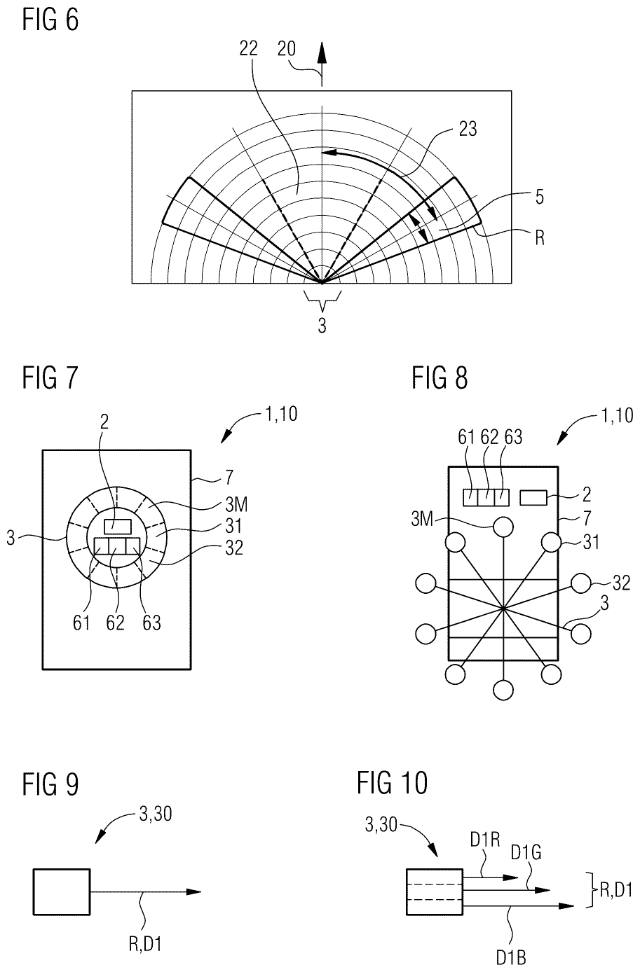

In FIG. 6, exemplary parameters of the emission directions D1 . . . DM are illustrated. For example, an angle 23 between an optical axis 20 of the image sensor 2 and the emission directions D1 . . . DM is about 60°. An emission angle width 5 of the emission directions D1 . . . DM may be about 30°in each case. Thus, no or virtually no radiation R is emitted by the light source 3 into the field 23 of view of the image sensor 2.

In FIGS. 7 and 8, exemplary embodiments of the picture recording arrangement 1 are shown. In both cases, the picture recording arrangement 1 is a mobile device 10, like a smartphone.

The light source 3 comprises a plurality of light-emitting units 31 . . . 3M. The light-emitting units 31 . . . 3M can be light-emitting diodes, LEDs for short. It is possible that the light-emitting units 31 . . . 3M are arranged in a circular manner, that is, on a circle. Because a distance between the light-emitting units 31 . . . 3M is very small compared with a distance between the illuminated areas 13, compare FIG. 2, it is not necessary that an arrangement order of the light-emitting units 31 . . . 3M corresponds to an arrangement order of the illuminated areas 13. Hence, it is alternatively also possible for the light-emitting units 31 . . . 3M to be arranged in a matrix, for example.

If the light-emitting units 31 . . . 3M are arranged on a circle, it is possible that the respective emission directions D1 . . . DM associated with the light-emitting units 31 . . . 3M can point inwards, that is, can cross a center of the circle.

Moreover, the picture recording arrangement 1 includes the at least one image sensor 2. Optionally, the picture recording arrangement 1 can include at least one of an additional light-emitting unit 61, an emitter 62 for non-visible radiation or a 3D-sensor 63. Further, the picture recording arrangement 1 comprises the processing unit 7 configured to perform the method described above. The processing unit 7 can be a main board or an auxiliary board of the picture recording arrangement 1.

According to FIG. 7, the light source 3 is integrated in a casing of the picture recording arrangement 1. The light-emitting units 31 . . . 3M are arranged around the image sensor 2. Optionally, the at least one of the additional light-emitting unit 61, the emitter 62 for non-visible radiation or the 3D-sensor 63 can also be located within the arrangement of the light-emitting units 31 . . . 3M, seen in top view of the image sensor 2.

Other than shown in FIG. 7, the at least one of the additional light-emitting unit 61, the emitter 62 for non-visible radiation or the 3D-sensor 63 as well as the image sensor 2 can be located outside of the arrangement of the light-emitting units 31 . . . 3M. as illustrated in FIG. 8.

Moreover, in FIG. 8 it is shown that the light-emitting units 31 . . . 3M are arranged in a spider-like manner. In this case, the arrangement of the light-emitting units 31 . . . 3M can protrude from the casing, but it can also be completely within the casing, seen in top view of the image sensor 2 and other than shown in FIG. 8.

Thus, it is possible that the light-source 3 can be an external unit mounted, like clamped or glued, on the casing. An electrical connection between the casing and the light-source 3 can be done by a USB type C connection, for example.

Otherwise, the same as to FIGS. 1 to 6 may also apply to FIGS. 7 and 8, and vice versa.

In FIG. 9, one exemplary light-emitting unit 31 of the light source 3 is illustrated. In this case, the light-emitting unit 31 has only one channel, that is, is configured to emit along the assigned emission direction D1 with a fixed color, for example. Said color is white light, for example.

Contrary to that, according to FIG. 10 the light-emitting unit 31 comprises three color channels for red, green and blue light, for example. Thus, three beams D1R, D1G, D1B are emitted along the assigned emission direction D1 to form the radiation R. The three color channels are preferably electrically addressable independent of one another so that an emission color of the light-emitting unit 31 can be tuned. For example, each color channel is realized by an own LED chip as the respective light emitter.

The light-emitting units 31 of FIGS. 9 and 10 can be used in all embodiments of the picture recording arrangement 1, also in combination with each other.

Otherwise, the same as to FIGS. 1 to 8 may also apply to FIGS. 9 and 10, and vice versa.

The invention described here is not restricted by the description on the basis of the exemplary embodiments. Rather, the invention encompasses any new feature and also any combination of features, which includes in particular any combination of features in the patent claims, even if this feature or this combination itself is not explicitly specified in the patent claims or exemplary embodiments.

1.-18. (canceled)

19. A method for adapting illumination comprising:
providing a picture recording arrangement comprising an image sensor and a light source, the light source configured to illuminate a scene comprising a target along different emission directions;
obtaining illumination information of at least one of a background of the scene or a reference image, the illumination information being based on a situation when the light source is turned off;
generating an optimized weight vector based on the illumination information, the optimized weight vector including at least one intensity value for each one of the emission directions; and
taking at least one target image of the target by controlling light emission of the light source along the emission directions according to the optimized weight vector, wherein the target is indirectly illuminated so that at least some of the emission directions point next to the target and not onto the target.

20. The method according to claim 19,
wherein the target is illuminated by the lights source exclusively in an indirect manner,
wherein orientations of the emission directions relative to the image sensor are fixed, and
wherein a diameter of the light source is at most 0.3 m, seen in top view of the images sensor.

21. The method according to claim 19,
wherein obtaining the illumination information comprises one or more of the following:
taking a low-light image of the scene with the light source being switched off,
estimating a three-dimensional representation of the scene within a field of view of the image sensor, and/or
estimating a three-dimensional representation of the scene next to the field of view of the image sensor,
wherein the illumination information comprises information about reflective surfaces next to the target.

22. The method according to claim 19, wherein obtaining the illumination information further comprises
analyzing illumination conditions of the reference image,
wherein the illumination information comprises information about at least one direction of illumination used to take the reference image.

23. The method according to claim 19,
wherein generating the optimized weight vector comprises one or more of the following:
feeding a neural network with the illumination information and running it to generate the optimized weight vector,
estimating from the illumination information reflective surfaces to be illuminated with the light source, and
calculating the optimized weight vector accordingly.

24. The method according to claim 19,
wherein generating the optimized weight vector further comprises
based on the illumination information, simulating an illumination of the scene for each one of the emission directions, wherein per simulation the light source is assumed to emit radiation only along a subset of the emission directions.

25. The method according to claim 19,
wherein an emission angle between an optical axis of the image sensor and at least some of the emission directions is between 30° and 75°, inclusive,
wherein for at least some of the emission directions an emission angle width per emission direction is between 15° and 45°, inclusive, and
wherein radiation emitted into the emission directions is emitted out of a field of view of the image sensor.

26. The method according to claim 19,
wherein there are at least 6 and at most 30 of the emission directions.

27. The method according to claim 19,
wherein the light source comprises one light-emitting unit for each one of the emission directions, and
wherein positions of the light-emitting units relative to one another are fixed,
wherein the light-emitting units are arranged in a circular manner, seen in top view of the image sensor.

28. The method according to claim 19,
wherein the light source comprises an additional light-emitting unit configured for direct lighting of the target.

29. The method according to claim 19,
wherein the method is performed indoor,
wherein the light source emits a photo flash for taking the at least one target image,
wherein a distance between the picture recording arrangement and the target is between 1 m and 6 m, inclusive.

30. The method according to claim 19,
wherein the light source emits independently a plurality of beams having different colors along at least some of the emission directions.

31. The method according to claim 19,
wherein the light source emits only a single beam of light along at least some of the emission directions.

32. The method according to claim 19,
wherein the light source comprises an emitter configured for non-visible radiation.

33. The method according to claim 19,
wherein the picture recording arrangement comprises a 3D-sensor,
wherein the 3D-sensor obtains three-dimensional information of the scene prior to generating the optimized weight vector.

34. The method according to claim 19,
wherein the picture recording arrangement is a single mobile device including the image sensor and the light source.

35. The method according to claim 34,
wherein the picture recording arrangement is a smart phone.

36. A mobile device comprising:
an image sensor;
a light source; and
a processor configured to obtain illumination information of at least one of a background of a scene comprising a target or a reference image, the illumination information being based on a situation when the light source is turned off,
wherein the processor is further configured to generate an optimized weight vector based on the illumination information, the optimized weight vector including at least one intensity value for each one of emission directions, and
wherein the image sensor is configured to take at least one target image of the target by controlling, by the processor, light emission of the light source along the emission directions according to the optimized weight vector.

37. A method for adapting illumination comprising:
providing a picture recording arrangement comprising an image sensor and a light source, the light source being configured to illuminate a scene comprising a target along different emission directions;
obtaining illumination information of at least one of a background of the scene or a reference image, the illumination information being based on a situation when the light source is turned off;
generating an optimized weight vector based on the illumination information, the optimized weight vector including at least one intensity value for each one of the emission directions; and
taking at least one target image of the target by controlling light emission of the light source along the emission directions according to the optimized weight vector,
wherein
the target is indirectly illuminated so that at least some of the emission directions point next to the target and not onto the target,
wherein orientations of the emission directions relative to the image sensor are fixed,
wherein radiation emitted into the emission directions is emitted out of a field of view of the image sensor, and
wherein generating the optimized weight vector comprises:
feeding a neural network with the illumination information and running it to generate the optimized weight vector,
estimating from the illumination information reflective surfaces to be illuminated with the light source and calculating the optimized weight vector accordingly, and/or
based on the illumination information, simulating an illumination of the scene for each one of the emission directions, wherein per simulating the light source it is assumed to emit the radiation only along a subset of the emission directions.
